(19) United States
(12) Patent Application Publication
(10) Pub. No.: US 2022/0346541 A1
(43) Pub. Date: Nov. 3, 2022

(54) Tri-Pad Scrubbing Device

(71) Applicant: Danilo C Foz, Martinez, CA (US)

(72) Inventor: Danilo C Foz, Martinez, CA (US)

(21) Appl. No.: 17/244,475

(22) Filed: Apr. 29, 2021

(51) Int. Cl. A46B 13/00; B60S 3/04; A46B 13/02; B25G 1/04; B25G 1/06

(52) U.S. Cl. CPC A46B 13/008; B60S 3/048; A46B 13/02; B25G 1/04; B25G 1/06; A46B 2200/3046

(57) ABSTRACT

A tri-pad scrubbing device primarily used for cleaning vehicles where the scrubbing pads are powered by a single gear motor and each pad is capable of rotating and tilting to conform to the compound curves of a vehicle to allow the pads to maintain full contact with the surface being scrubbed. The tri-pad assembly is attached to the distal end of an adjustable length extension pole. A rechargeable battery power supply, which powers the gear motor, is removably mounted near the proximal end of the extension pole. The tri-pad assembly is attached to the distal end of the extension pole via a rotating and locking hinge mechanism. A push button switch is provided near the extension pole handle end.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of vehicle scrubbing devices and more particularly to an electro-mechanical three pad rotating assembly attached to an extension pole. Currently, people who wish to clean their vehicles can either scrub by hand with a cloth or brush or use a powered device such as an electric drill with a scrubbing pad affixed to it or a dedicated hand-held rotating scrubber which includes an electric motor and attached scrubbing pad such as the “Pure Clean Compact & Portable Car Wash, Waterproof Motorized Electric Automatic Cleaner Scrubber” available at Walmart. However, the scrubbers available on the market today employ a cleaning head diameter of between four and five inches. This small diameter is needed because using a larger diameter head would make it difficult to maintain flat contact with the compound curved surfaces found on a typical vehicle. The small cleaning head diameter means that it will take longer to clean the entire vehicle. The present invention uses three floating heads each approximately five inches in diameter creating a cleaning area of approximately ten- and one-half inches across. Because the cleaning heads can tilt as well as rotate, they can conform to compound curved surfaces even though the area covered is twice that of currently existing motorized scrubbers.

### BRIEF SUMMARY OF THE INSTANT INVENTION

The primary object of the invention is to provide a unique tri-pad scrubber primarily used for cleaning vehicles where the scrubbing pads are powered by a single gear motor and each pad is capable of rotating and tilting to conform to the compound curves of a vehicle to allow the pads to maintain full contact with the surface being scrubbed. The tri-pad assembly is attached to the distal end of an adjustable length extension pole. A rechargeable battery power supply, which powers the gear motor, is removably mounted near the proximal end of the extension pole. The tri-pad assembly is attached to the distal end of the extension pole via a rotating and locking hinge mechanism. A push button switch near the distal end of the extension pole can turn the gear motor on or off.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a tri-pad scrubbing device comprising a direct current gear motor, a drive gear, three satellite gears, three scrubbing pad holders, three scrubbing pads, a rotating locking hinge assembly, an extension pole a battery power supply, a battery holder, a right angle handle and at least one on/off switch, the drive gear attached to the shaft of the direct current gear motor, the three satellite gears engaging the drive gear, the direct current motor and the gears all enclosed in a hollow housing, the hollow housing attached at one side of the rotating locking hinge assembly, the distal end of the extension pole attached to the opposite side of the rotating locking hinge assembly, the extension pole made up of two telescoping members that can lock at the desired length via a cam lock assembly, the right angle handle attached to the extension pole, the rechargeable battery removably attached to the battery holder mounted near the proximal end of the extension pole the on/off switch mounted within the extension pole and extending through the extension pole to be accessed by a user.

### BRIEF DESCRIPTION OF THE DRAWINGS

The drawings constitute a part of this specification and include exemplary embodiments to the instant invention, which may be embodied in various forms. It is to be understood that in some instances various aspects of the instant embodiments may be shown exaggerated or enlarged to facilitate an understanding of the instant embodiment.

FIG. 1 is a perspective view of the embodiment.

FIG. 2 is a side view of the embodiment.

FIG. 3 is a partial perspective view of the tri-pad assembly.

FIG. 4 is a partial perspective view of the tri-pad assembly in the bent position.

FIG. 5 is a partial perspective view of the tri-pad assembly with the extension pole in the extended position.

FIG. 6 is a partial perspective view of the embodiment with the extension pole in the retracted position.

FIG. 7 is a partial perspective view of the extension pole and right-angle handle.

FIG. 8 is a partial perspective view with the right-angle handle slid to the far end of the first telescoping pole.

FIG. 9 is a section view of the right-angle handle.

FIG. 10 is an exploded view of the embodiment.

FIG. 11 is a partial perspective view with the battery removed.

FIG. 12 is a section view of the rotating locking hinge assembly.

### DETAILED DESCRIPTION OF THE PREFERRED EMBODIMENTS

Detailed descriptions of the preferred embodiment are provided herein. It is to be understood, however, that the present embodiment may be embodied in various forms. Therefore, specific details disclosed herein are not to be interpreted as limiting, but rather as a basis for the claims and as a representative basis for teaching one skilled in the art to employ the present embodiment in virtually any appropriately detailed system, structure or manner.

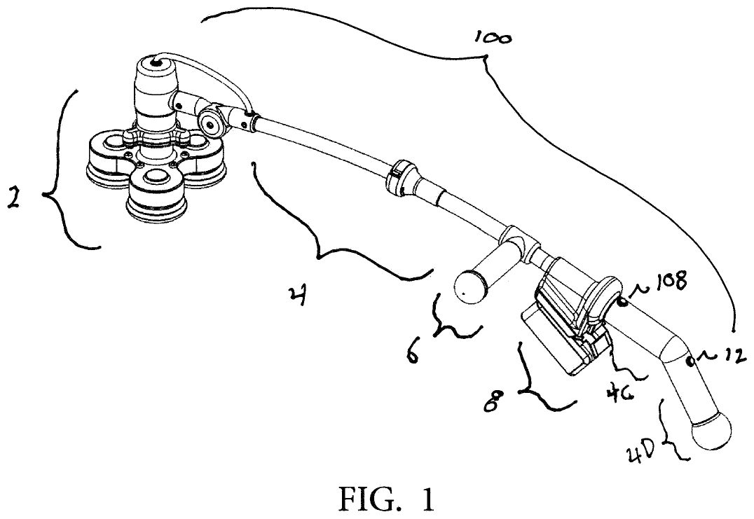

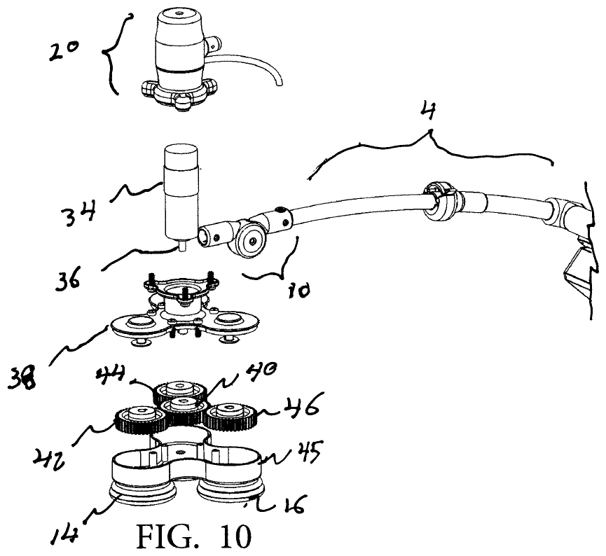

Referring now to FIG. 1 we see a perspective view of the embodiment 100. A tri-pad head scrubbing assembly 2 is attached to the distal end of extension pole 4. A right-angle handle 6 is attached to the extension pole 4 to act as one hand holding member. The additional hand holding member is at the proximal end of extension pole 4 and includes two possible hand holding locations 4C, 4D depending on what angle the user wished to hold the entire device 100. A battery holder and rechargeable battery assembly 8 powers a gear motor 34 located housing 20 as shown in FIG. 10. One of two on/off switches 108, 12 can used depending on where the user's hand is located on the distal end 4C, 4D of pole 4.

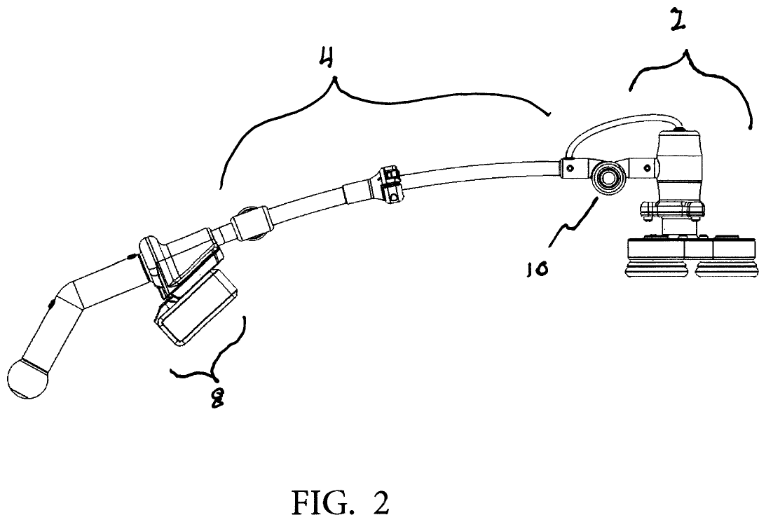

FIG. 2 is a side view of the embodiment 100 showing the extension pole 4 is slightly radiused thereby allowing a more positive ergonomic experience when scrubbing the top portion of a vehicle. Rotating, locking hinge assembly 10 lets the user adjust the angle of tri-pad head 2 depending on the height and distance of the item being scrubbed in relation to the user's hands and arms.

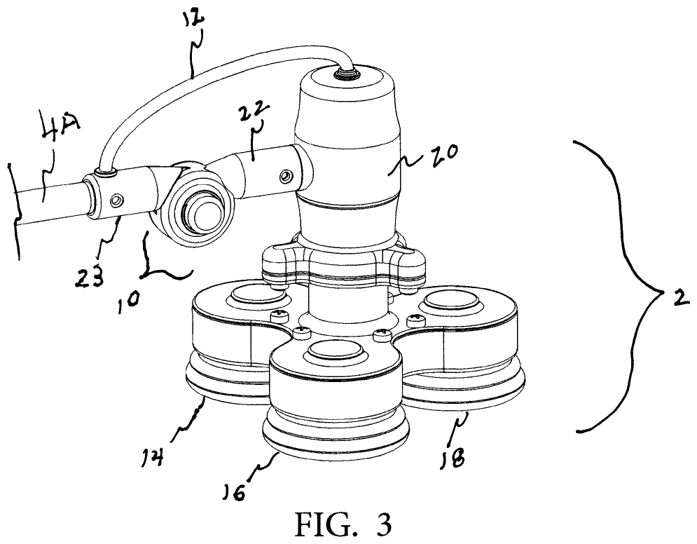

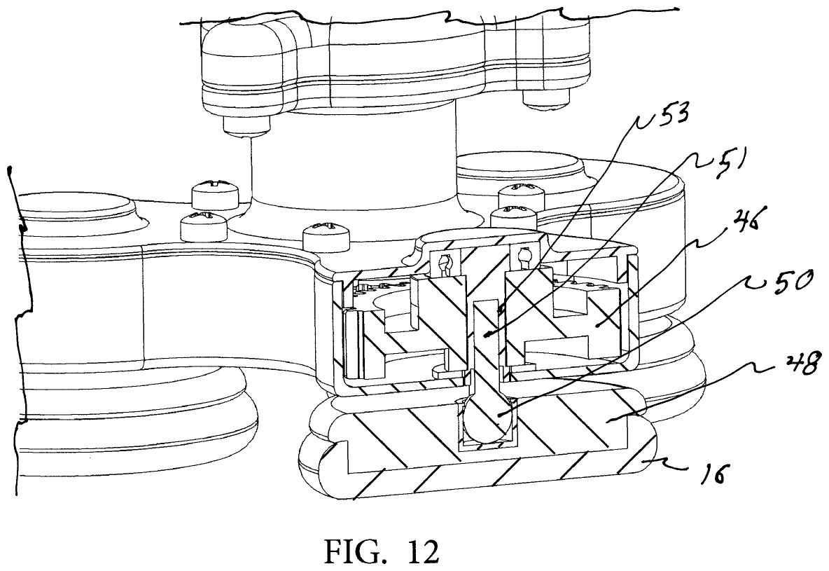

FIG. 3 is a partial perspective view of the tri-pad assembly 2. A centrally located motor housing 20 retains a direct current powered gear motor 34, shown in FIG. 10, which powers the scrubbing pads 14, 16, 18 and causes them to rotate, the pads are mounted using a ball joint assembly as shown in FIG. 12 to allow them to “float” or tilt as they rotate so that the pads can accommodate any compound curved surface while the pads 14, 16, 18 maintain contact with the surface. Each pad 14 is approximately five inches in diameter. The combination of pads 14, 16, 18 allows creates a cleaning surface of approximately ten-and-one-half inches across, which is significantly larger than competitive cleaning pads thereby allowing the user to scrub a vehicle in less time using the present embodiment 100. Tri-pad housing 2 is attached to a rotating, locking hinge assembly 10 via connector 22. The opposite side connector of hinge assembly 23 is attached to extension pole member 4A. A power cord 12 extends from the motor housing 20 to connector 23 and then travels within a hollow space in extension pole 4 to the battery assembly 8 and switches 108, 12.

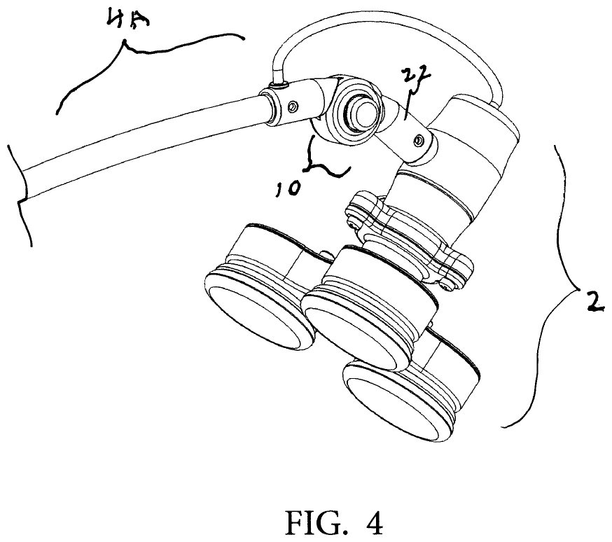

FIG. 4 is a partial perspective view showing hinge assembly 10 rotated to an angled position causing the tri-pad assembly 2 to angle inward which can also help create a smaller overall size for shipping and storage.

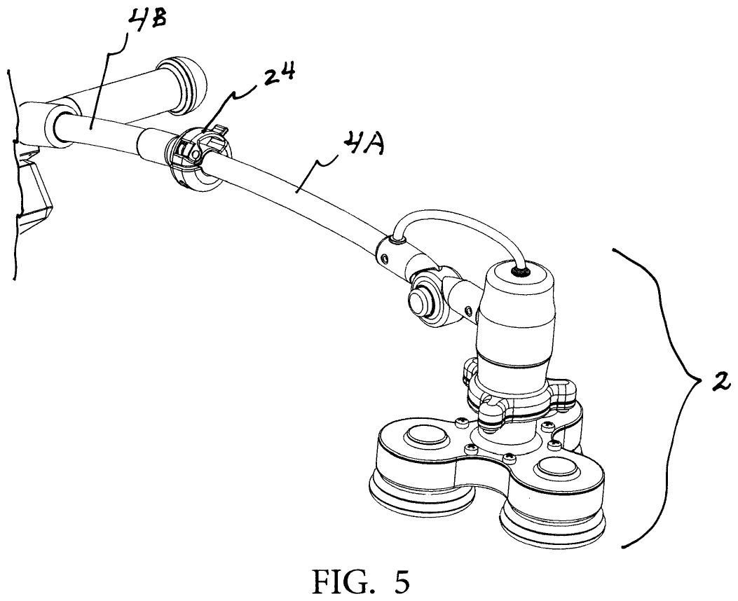

FIG. 5 is a partial perspective view showing telescoping pole 4A in the fully extended position which is ideal for scrubbing the top surfaces of a vehicle. Cam lock 24 holds the extended pole 4A in place during use.

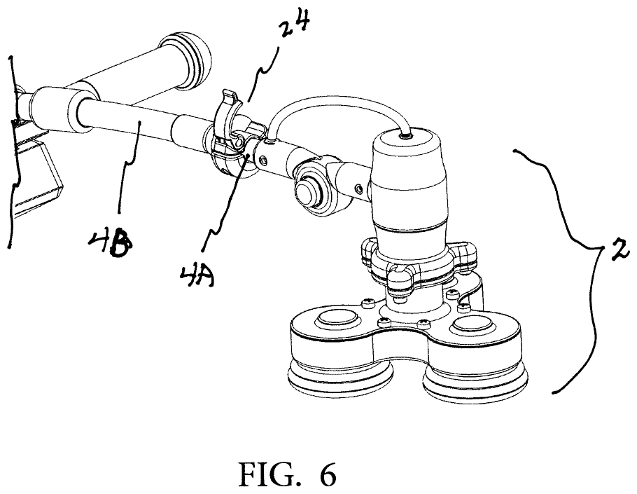

FIG. 6 is a partial perspective view showing the telescoping pole 4A in the fully retracted position, which is ideal for scrubbing surfaces that are relatively close to the user. It is also ideal for compact storage and shipping.

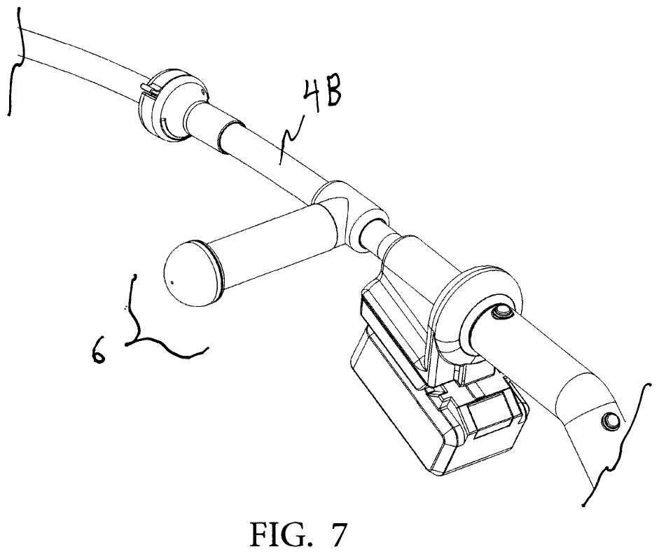

FIG. 7 is a partial perspective view showing the right-angle handle assembly 6 locked in a position that is close to the proximal end of the extension pole 4B.

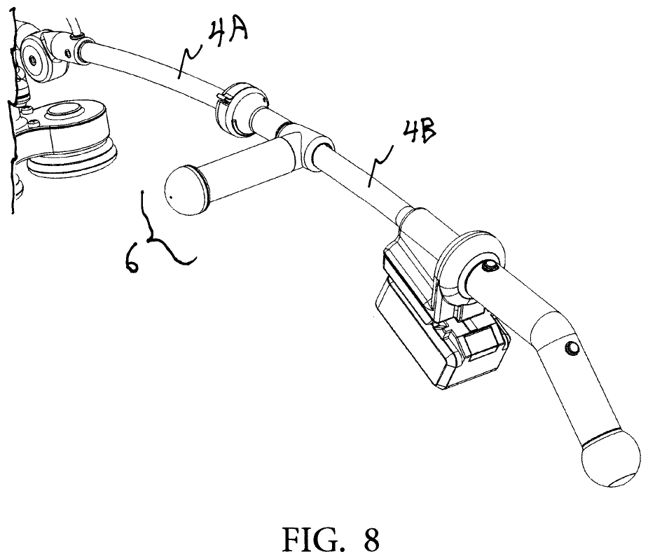

FIG. 8 is a partial perspective view showing the right-angle handle assembly 6 locked in a position further away from the proximal end of the telescoping pole 4B. The ability to adjust the location of right-angle handle 6 allows the user to balance the weight of the battery assembly 8 and the tri-pad assembly 2 depending on how extended or retracted the telescoping pole 4B is.

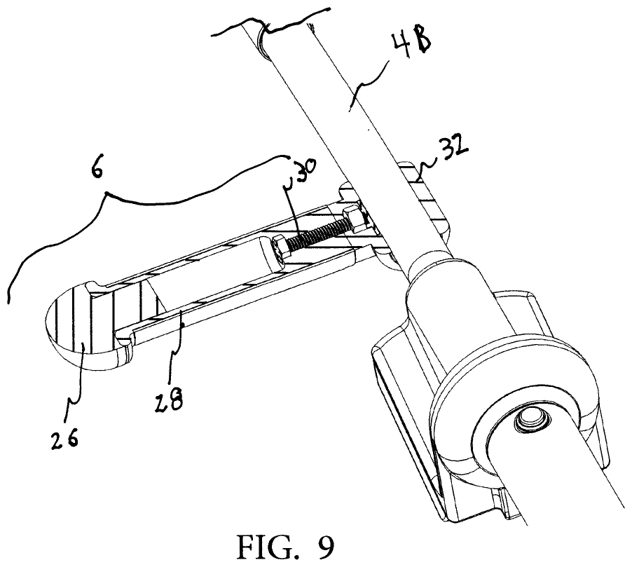

FIG. 9 is a partial section view of right-angle handle assembly 6. The free end 26 of the handle assembly 6 can be rotated to release the grip of threaded post 30 on the side of pole 4B as it is encased by sleeve 32. The user can turn the knob 26 counterclockwise to loosen the grip of post 30 and then slide the handle assembly 6 up or down on the pole 4B as needed and turning the knob 26 clockwise for tightening and eventually balancing the weight of the battery assembly 8 with the weight of the tri-pad assembly 2.

FIG. 10 is an exploded view of the tri-pad assembly 2. Housing 20 encloses a direct current gear motor 34. A central drive gear 40 is fixedly attached to shaft 36 of the gear motor 34. Three satellite gears 42, 44, 46 are arranged equidistant from each other and all engage the central drive gear 40. The heads of scrubber pad 14, 16, 18 are each centrally attached to the centers of satellite gears 42, 44, 46. Separator plate 38 traps the gears 40, 42, 44, 46 in place and attaches to the underside of hollow housing 20 by screws, not shown. Lower housing 45 encloses the satellite gears 40, 42, 44, 46 from underneath.

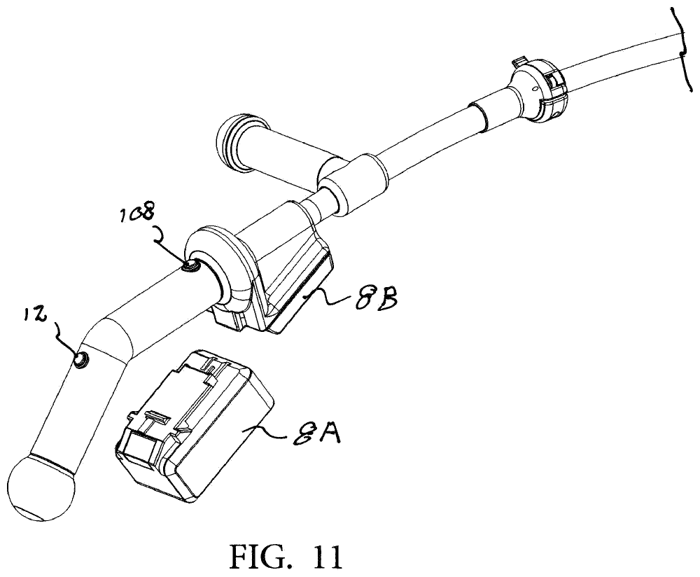

FIG. 11 is a partial perspective view showing the rechargeable battery 8A removed from battery holder 8B. The battery 8A can now be inserted into a battery charger, not shown, for recharging.

FIG. 12 is a section view showing a single scrubbing pad 16 attached to a scrubbing pad holder 48. The pad holder 48 has a cylindrical cutout at its center which engages the ball portion 50 of a drive post 51. The drive post 51 is engaged by a centrally located aperture 53 in gear 46. Because of the nature of the ball and socket design, the pad 16 can tilt as well as rotate to accommodate a variety of compound curves found on a typical vehicle.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A tri-pad scrubbing device comprising:
a telescoping extension pole assembly, the telescoping extension pole having a proximal holding end and a distal motor end;
a tri-pad scrubbing assembly attached to the telescoping extension pole at the distal motor end;
a removable battery holder housing a battery power supply mounted on the telescoping extension pole;
a right angle handle; and
a. the tri-pad scrubbing assembly comprising:
a hollow housing comprising: a direct current gear motor comprising a shaft, a center drive gear attached to the shaft of the direct current gear motor, three satellite gears engaging the drive gear, three scrubbing pad holders, three scrubbing pads;
wherein each satellite gear comprises a centrally located aperture that retains a drive post, each drive post furthermore engaging each pad holder via a ball joint assembly, wherein the ball joint assembly comprises a ball shaped socket to enable the scrubbing pads to tilt while rotating during use accommodating a variety of compound curved surfaces being scrubbed, the scrubbing pads each removably attached to each the scrubbing pad holder;
wherein the direct current motor and the satellite gear are all enclosed in the hollow housing; the hollow housing attached to a connector fixed to one side of a rotating locking hinge assembly, the distal motor end of the telescoping extension pole attached to a connector fixed to the opposite side of the rotating locking hinge assembly;
b. the extension pole assembly comprising:
a distal telescoping pole member near the distal motor end and a proximal telescoping pole member, the two pole members locked to desired length via a cam lock assembly;
a right angle handle slidably attached to the proximal extension pole member;
the removable battery holder housing the battery power supply removably mounted on the proximal telescoping pole member near the proximal holding end; and
a direct current motor power control on/off switch comprising an activation button, mounted on the proximal telescoping pole member near the proximal holding end wherein the activation button extends to the outside of the pole to be accessed by a user.

2. A tri-pad scrubbing device as claimed in claim 1 wherein the right angle handle can be loosened and slid forward or backward on the proximal extension pole member and then locked again between the tri-pad scrubbing assembly and the battery holder to allow for weight balancing suitable to a specific user point.

3. A tri-pad scrubbing device as claimed in claim 1 wherein the extension pole assembly may comprise a second direct current motor power control on/off switch mounted at a second location on the telescoping extension pole to enable a user to control the direct current motor while holding onto a different area of the telescoping extension pole.
